(19) United States
(12) Patent Application Publication
(10) Pub. No.: US 2025/0055161 A1
(43) Pub. Date: Feb. 13, 2025

(54) LASER WELDING OF STACKS OF EXTERNAL TABS OF ELECTRODES TO TERMINALS

(71) Applicant: GM GLOBAL TECHNOLOGY OPERATIONS LLC, Detroit, MI (US)

(72) Inventors: Masoud MOHAMMADPOUR, Novi, MI (US); Teresa Jean RINKER, Royal Oak, MI (US); Junjie MA, Novi, MI (US); Chih-chang CHEN, Rochester Hills, MI (US); Andrew HROMADKA, Ann Arbor, MI (US); Blair E. CARLSON, Ann Arbor, MI (US); Jennifer Therese BRACEY, Holly, MI (US)

(21) Appl. No.: 18/447,405

(22) Filed: Aug. 10, 2023

(51) Int. Cl. H01M 50/566; B23K 26/0622; B23K 26/22; B23K 26/244; B23K 26/354; H01M 50/342

(52) U.S. Cl. CPC H01M 50/566; B23K 26/0622; B23K 26/22; B23K 26/244; B23K 26/354; H01M 50/342

(57) ABSTRACT

A method for joining external tabs of a battery cell to a terminal includes providing a battery cell stack; arranging a stack of external tabs of one of C cathode electrodes and A anode electrodes on a terminal; laser melting ends of the stack of external tabs; and after the laser melting, laser welding the stack of external tabs of the one of the C cathode electrodes and the A anode electrodes to the terminal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to laser welding of stacks of external tabs of electrodes to terminals of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for joining external tabs of a battery cell to a terminal, comprises providing a battery cell stack including: C cathode electrodes each including a cathode current collector made of foil, a cathode active layer arranged on the cathode current collector, and an external tab extending from the cathode current collector; A anode electrodes including an anode current collector made of foil, an anode active layer arranged on the anode current collector, and an external tab extending from the anode current collector; and S separators, where C, S and A are integers greater than one. The method includes arranging a stack of external tabs of one of the C cathode electrodes and the A anode electrodes on a terminal; laser melting ends of the stack of external tabs; and after the laser melting, laser welding the stack of external tabs of the one of the C cathode electrodes and the A anode electrodes to the terminal.

In other features, a first laser heats the ends of the stack of external tabs and performs the laser welding. The method includes adjusting at least one of laser power, laser scan speed, laser focus/defocus, laser oscillation pattern, workpiece speed, pulse frequency, and/or pulse shape of the first laser between the laser melting and the laser welding.

In other features, a first laser performs laser melting and a second laser performs the laser welding. The first laser uses different operating parameters than the second laser. At least one of laser power, laser scan speed, laser focus/defocus, workpiece speed, laser oscillation pattern, pulse frequency, and/or pulse shape of the second laser is different than the first laser.

A method for joining external tabs of a battery cell to a terminal includes providing a battery cell stack including: C cathode electrodes each including a cathode current collector made of foil, a cathode active layer arranged on the cathode current collector, and an external tab extending from the cathode current collector; A anode electrodes including an anode current collector made of foil, an anode active layer arranged on the anode current collector, and an external tab extending from the anode current collector; and S separators, where C, S and A are integers greater than one. The method includes arranging a stack of external tabs of one of the C cathode electrodes and the A anode electrodes on a terminal; creating L spot welds between the stack of external tabs and the terminal using a laser, where L is an integer greater than one; and laser welding the stack of external tabs of the one of the C cathode electrodes and the A anode electrodes to the terminal.

In other features, a first laser forms the L spot welds and performs the laser welding. The method includes adjusting at least one of laser power, laser scan speed, laser focus/defocus, laser oscillation pattern, workpiece speed, pulse frequency, and/or pulse shape of the first laser between the L spot welds and the laser welding. A first laser forms the L spot welds and a second laser performs the laser welding. The first laser uses different operating parameters than the second laser.

In other features, least one of laser power, laser scan speed, laser focus/defocus, workpiece speed, laser oscillation pattern, pulse frequency, and/or pulse shape of the second laser is different than the first laser. The laser welding comprises at least one of a lap weld and an edge weld.

A method for joining external tabs of a battery cell to a terminal includes providing a battery cell stack including: C cathode electrodes each including a cathode current collector made of foil, a cathode active layer arranged on the cathode current collector, and an external tab extending from the cathode current collector; A anode electrodes including an anode current collector made of foil, an anode active layer arranged on the anode current collector, and an external tab extending from the anode current collector; and S separators, where C, S and A are integers greater than one. The method includes forming a gas relief channel between a stack of external tabs of the one of the C cathode electrodes and the A anode electrodes and a terminal; and laser welding the stack of external tabs of the one of the C cathode electrodes and the A anode electrodes to the terminal.

In other features, forming the gas relief channel includes arranging a rod on a terminal; and arranging a stack of external tabs of one of the C cathode electrodes and the A anode electrodes on the rod and the terminal to form the gas relief channel.

In other features, a cross section of the rod is selected from a group consisting of semicircular, rectangular, polygonal, triangular, square, and circular.

In other features, forming the gas relief channel further includes clamping the stack of external tabs of one of the C cathode electrodes and the A anode electrodes to the terminal on opposite sides of the rod; and removing the rod between the stack of external tabs of one of the C cathode electrodes and the A anode electrodes and the terminal prior to the laser welding.

In other features, the terminal includes a groove and the gas relief channel is formed between the stack of external tabs of the one of the C cathode electrodes and the A anode electrodes and the groove of the terminal. The laser welding comprises at least one of a lap weld and an edge weld.

A method for joining external tabs of a battery cell to a terminal includes providing a battery cell stack including: C cathode electrodes each including a cathode current collector made of foil, a cathode active layer arranged on the cathode current collector, and an external tab extending from the cathode current collector; A anode electrodes including an anode current collector made of foil, an anode active layer arranged on the anode current collector, and an external tab extending from the anode current collector; and S separators, where C, S and A are integers greater than one. The method includes arranging a stack of external tabs of the one of the C cathode electrodes and the A anode electrodes at a first acute angle relative to a terminal; and laser welding ends of the stack of external tabs of the one of the C cathode electrodes and the A anode electrodes to the terminal.

In other features, the ends of the stack of external tabs are trimmed a second acute angle and wherein a trimmed surface of the ends faces the terminal prior to the laser welding of the ends. The ends of the stack of external tabs are trimmed a second acute angle and a trimmed surface of the ends faces away from the terminal prior to the laser welding, and further comprising biasing the ends of the stack of external tabs against the terminal to bend the stack of external tabs against the terminal prior to the laser welding of the ends.

A method for joining external tabs of a battery cell to a terminal includes providing a battery cell stack including: C cathode electrodes each including a cathode current collector made of foil, a cathode active layer arranged on the cathode current collector, and an external tab extending from the cathode current collector; A anode electrodes including an anode current collector made of foil, an anode active layer arranged on the anode current collector, and an external tab extending from the anode current collector; and S separators, where C, S and A are integers greater than one. The method includes arranging a stack of external tabs of the one of the C cathode electrodes and the A anode electrodes against a terminal wherein a length of the terminal is oriented within 30° of vertical; laser heating the terminal above ends of the stack of external tabs to cause a melted portion of the terminal to flow onto the ends of the stack of external tabs; and laser welding the stack of external tabs of the one of the C cathode electrodes and the A anode electrodes to the terminal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators according to the present disclosure;

FIG. 2A is a perspective view of an example of a pouch battery cell including a stack of external tabs of anode or cathode electrodes welded to a terminal according to the present disclosure;

FIG. 2B is a perspective view of an example of a prismatic battery cell including a stack of external tabs of anode or cathode electrodes welded to an internal terminal according to the present disclosure;

FIG. 2C is a side cross sectional view of an example of internal and external terminals of a prismatic battery cell according to the present disclosure;

FIGS. 3A to 3C illustrate an example of a method for laser welding a stack of external tabs of anode or cathode electrodes to a terminal arranged in a fixture by melting the external tabs and then laser welding according to the present disclosure;

FIGS. 4A to 4C illustrate another example of a method for laser welding a stack of external tabs of anode or cathode electrodes to a terminal by melting the external tabs and then laser welding according to the present disclosure;

FIGS. 5A to 5C illustrate another example of a method for laser welding a stack of external tabs of anode or cathode electrodes to a terminal by laser spot welding and then laser welding according to the present disclosure;

FIGS. 6A to 6C illustrate another example of a method for laser welding a stack of external tabs of anode or cathode electrodes to a terminal by clamping the stack of external tabs over a rod and then removing the rod to form a gas relief channel according to the present disclosure;

FIGS. 7A to 7C illustrate another example of a method for laser welding a stack of external tabs of anode or cathode electrodes to a terminal including a groove forming a gas relief channel according to the present disclosure;

FIGS. 8A and 8B illustrate another example of a method for laser welding ends of a stack of external tabs of anode or cathode electrodes to a terminal at an angle according to the present disclosure;

FIGS. 9A and 9B illustrate another example of a method for laser welding ends of a stack of external tabs of anode or cathode electrodes to a terminal at an angle according to the present disclosure; and

FIGS. 10A to 10D illustrate another example of a method for laser welding a stack of external tabs of anode or cathode electrodes to a terminal using autogenous brazing according to the present disclosure.

In the drawings, reference numbers may be reused to identify similar and/or identical elements.

### DETAILED DESCRIPTION

While battery cells including laser welded terminals are shown in the context of electric vehicles, the battery cells including laser welded terminals can be used in stationary applications and/or other applications.

The present disclosure addresses quality issues of welds between external tabs extending from current collectors of anode and/or cathode electrodes and terminals of a battery cell. In some examples, the terminals are laser welded to a stack of the external tabs of the cathode or anode electrodes in a pouch battery cell. The terminals extend through a pouch enclosure.

In some examples, the terminals are internal terminals of a prismatic battery cell that are in contact with external terminals of the prismatic battery cell. In other words, the external terminals are in contact with the internal terminals that are laser welded to the external tabs of the cathode electrodes and/or anode electrodes. As can be appreciated, separate terminals are used to connect to the cathode and anode electrodes, respectively, to external devices. While prismatic and pouch battery cells are shown for purposes of illustration, other battery cell form factors can be used.

When welding multiple layers of external tabs (e.g., external tabs extending from current collectors made of foil), the weld may be porous and detachments may occur at a boundary of fusion. When laser welding is used, defects can be created. The present disclosure relates to joining of the stack of external tabs of the current collectors of anode and/or cathode electrodes to the terminals using various laser welding methods to reduce or eliminate defects and improve weld quality. In some examples, laser welding is performed with or without prior ultrasonic welding.

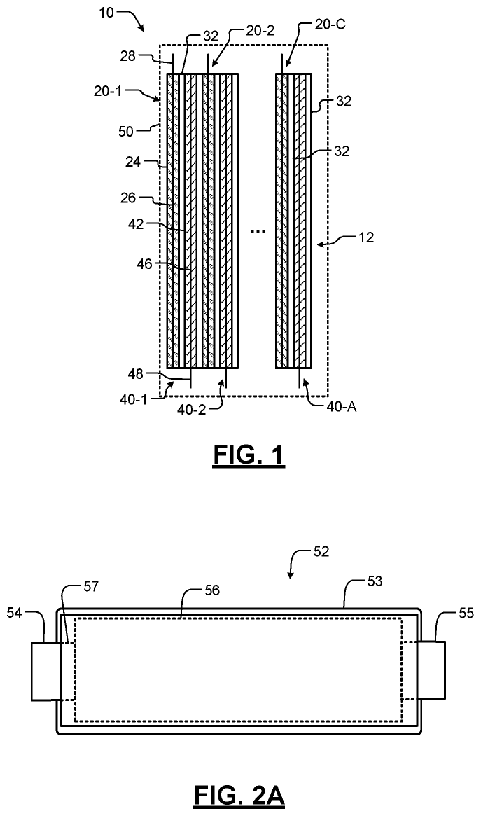

Referring now to FIG. 1, a battery cell 10 includes C cathode electrodes 20, A anode electrodes 40, and S separators 32 arranged in a predetermined sequence in a stack 12 arranged in an enclosure 50. The cathode electrodes 20-1, 20-2, . . . , and 20-C (where C is an integer greater than one) include cathode active material layers 24 arranged on one or both sides of cathode current collectors 26. The A anode electrodes 40-1, 40-2, . . . , and 40-A (where A is an integer greater than one) include anode active material layers 42 arranged on one or both sides of the anode current collectors 46.

Connections to the C cathode electrodes 20 and the A anode electrodes 40 are typically made to terminals. The C cathode electrodes 20 and the A anode electrodes 40 include external tabs 28 and 48, respectively. The external tabs correspond to portions of the current collectors of the C cathode electrodes 20 and the A anode electrodes 40 that extend beyond edges of the cathode active material layer 24 or the anode active material layer 42.

In some examples, the external tabs 28 of the C cathode electrodes 20 are connected to a terminal and external tabs 48 of the A anode electrodes 40 are connected to another terminal. The terminals extend through the battery cell enclosure or are connected to external terminals of the battery cell that extend through the battery cell enclosure. While a length of the external tabs 28 and 48 is illustrated as relatively short in FIG. 1, the external tabs 28 and 48 can extend any distance needed for welding or other purposes. The external tabs 28 and 48 can include a single external tab per electrode or multiple external tabs per electrode to provide a redundant connection. The external tabs 28 and 48 can extend the width of the current collectors or only a portion of the width of the current collectors.

In some examples, the cathode current collectors 26 and the anode current collectors 46 comprise foil layers. In some examples, the current collectors are made of one or more materials selected from a group consisting of copper, stainless steel, brass, bronze, zinc, aluminum, and alloys thereof. In some examples, the anode active material layers 42 and/or the cathode active material layers 24 comprise free-standing cathode or anode active layers. In other examples, the anode active material layers 42 and/or the cathode active material layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process.

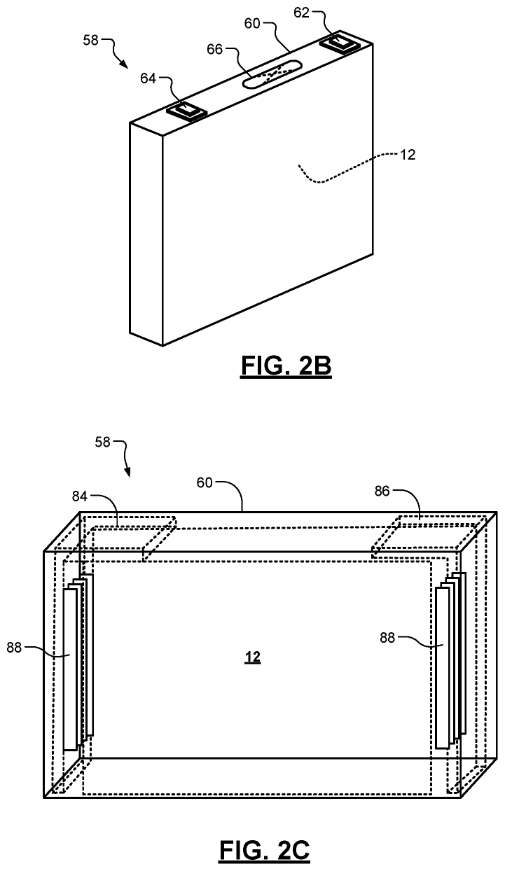

Referring now to FIG. 2A, a pouch battery cell 52 includes a pouch enclosure 53 including a battery cell stack 56. As will be described further below, external tabs 57 of the anode and cathode electrodes are laser welded to terminals 54 and 55, respectively, that extend through the pouch enclosure 53.

Referring now to FIG. 2B, a prismatic battery cell 58 includes an enclosure 60. In some examples, the enclosure 60 has rectangular cross-sections in x-, y- and z-axis planes. The prismatic battery cell 58 includes external terminals 62 and 64 and a vent cap 66. The stack 12 of the C cathode electrodes 20, the A anode electrodes 40, and the S separators 32 is arranged in the enclosure 60. As will be described further below, external tabs of the anode current collectors and/or the cathode current collectors are laser welded to the corresponding terminals. The terminals are arranged in contact with the external terminals 62 and 64 of the battery cell 10 to provide external connections to the anode electrodes and cathode electrodes.

Referring now to FIG. 2C, examples of internal terminals 84 and 86 of a prismatic battery cell are shown in the enclosure 60. The stack 12 of the A anode electrodes or the C cathode electrodes include external tabs 88. The external tabs 88 of the A anode electrodes and/or the C cathode electrodes are laser welded to the internal terminals 84 and 86, respectively, as will be described further below. While the internal terminals 84 and 86 are shown as “L”-shaped terminals, planar terminals or terminals having other shapes can be used.

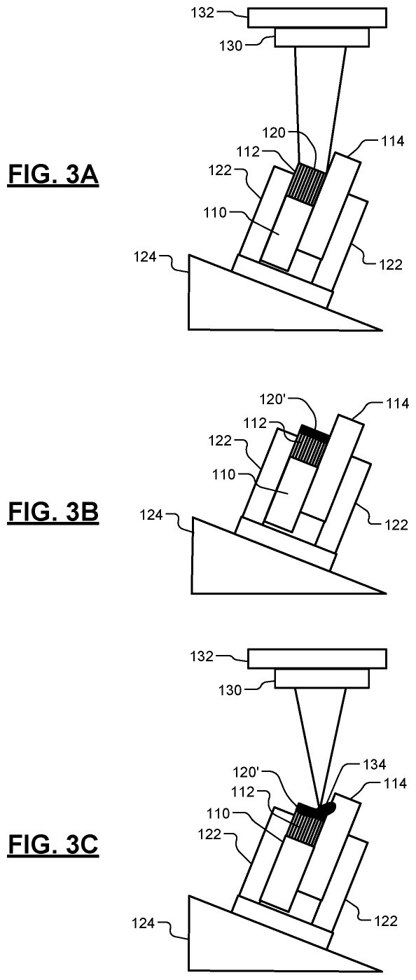

Referring now to FIGS. 3A to 3C, a method is shown for laser welding a stack of external tabs 112 of anode or cathode electrodes of a battery cell stack 110 to a terminal 114 by melting and then laser welding the stack of external tabs 112. The stack of external tabs 112 and the terminal 114 are mounted in a fixture 124 including a vise 122 configured to hold the stack of external tabs 112 and the terminal 114 together during laser welding. A scanner 132 is attached to a laser 130 and is configured to move a laser beam output by the laser 130 on the stack of external tabs 112 and/or the terminal 114. While the scanner 132 can be used to move the laser 130, the fixture 124 can be moved by an actuator to move the battery cell stack 110 relative to the laser (e.g., instead of or in addition to movement by the scanner 132).

In FIG. 3A, the scanner 132 directs the laser beam output by the laser 130 onto ends 120 of the stack of external tabs 112 to melt the ends 120 of the stack of external tabs 112. In FIG. 3B, the ends 120 of the stack of external tabs 112 are partially melted as shown at 120′. In FIG. 3C, the scanner 132 directs the laser beam output by the laser 130 onto the ends 120′ of the stack of external tabs 112 and the terminal 114 to create a weld 134 between the stack of external tabs 112 and the terminal 114.

In some examples, the laser 130 is arranged at an acute angle relative to the stack of external tabs 112 and the terminal 114. In some examples, the laser 130 is defocused during the melting and focused during the laser welding. In some examples, the scanner 132 uses a first scan speed during the melting and a second scan speed (less than the first scan speed) during the laser welding. In some examples, the laser 130 uses beam oscillation during the laser welding. In some examples, the laser 130 uses power modulation during the laser welding. As an be appreciated, the laser weld can partially or fully penetrate the terminal 114.

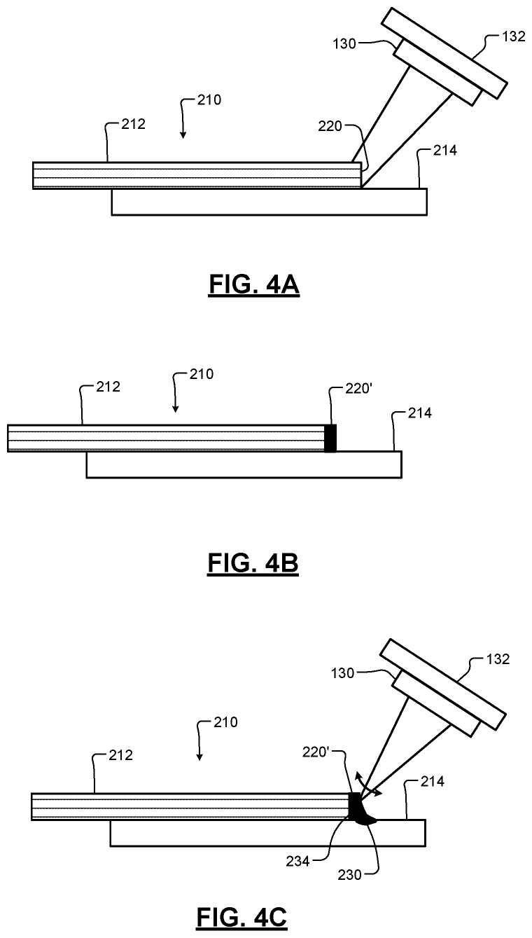

Referring now to FIGS. 4A to 4C, a method for laser welding a stack of external tabs 212 of anode or cathode electrodes of a battery cell stack 210 to a terminal 214 is shown. The stack of external tabs 212 and the terminal 214 are mounted in a fixture 224 including a vise 222 configured to hold the stack of external tabs 212 and the terminal 214. A scanner 132 is attached to a laser 130 and is configured to direct the laser 130 onto the stack of external tabs 212 and/or the terminal 214.

In FIG. 4A, the scanner 132 directs the laser beam output by the laser 130 onto ends 220 of the stack of external tabs 212 to melt the ends 220 of the stack of external tabs 212. In FIG. 4B, ends 220′ of the stack of external tabs 212 are melted. In FIG. 4C, the scanner 132 directs the laser beam output by the laser 130 onto the ends 220′ of the stack of external tabs 212 and the terminal 214 to form a weld 234 between the stack of external tabs 212 and the terminal 214.

In some examples, the laser 130 is arranged at an angle relative to the stack of external tabs 212 and the terminal 214. In some examples, the laser 130 is defocused during the melting and focused during the laser welding. In some examples, the scanner 132 uses a first scan speed during the melting and a second scan speed (less than the first scan speed) during the laser welding. In some examples, the laser 130 uses beam oscillation during the laser welding. In some examples, the laser 130 uses power modulation during the laser welding. As an be appreciated, the laser weld can partially or fully penetrate the terminal 214.

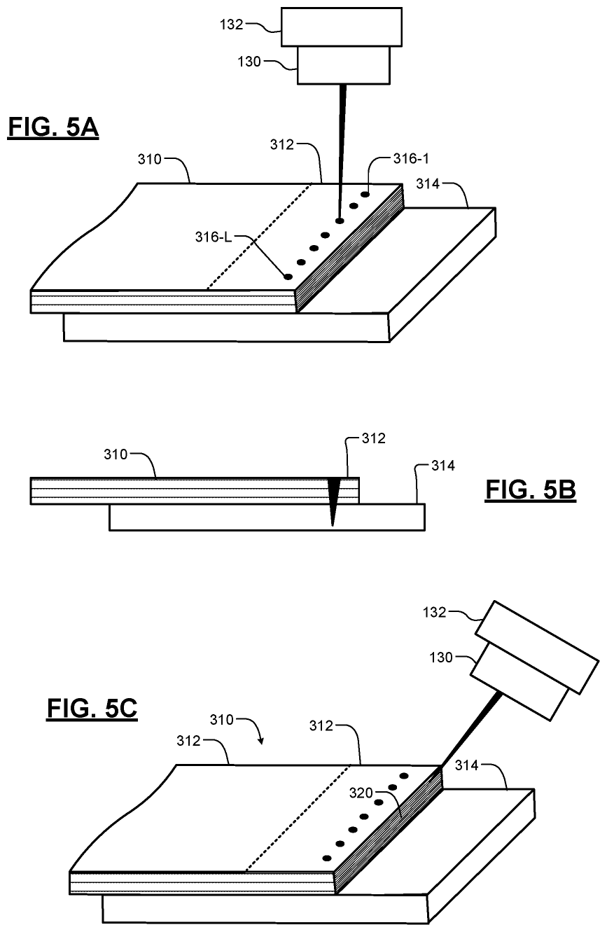

Referring now to FIGS. 5A to 5C, a method for laser welding a stack of external tabs 312 of anode or cathode electrodes of a battery cell stack 310 to a terminal 314 is shown. In FIGS. 5A and 5B, the scanner 132 moves the laser beam output by the laser 130 to a plurality of locations on the terminal 314 to generate a plurality of spot welds 316-1, . . . , and 316-L, where L is an integer greater than one. The plurality of spot welds 316-1, . . . , and 316-L tack the ends of the stack of external tabs 312 to the terminal 314 prior to laser welding. In some examples, the plurality of spot welds 316-1, . . . , and 316-L are arranged along one or more lines parallel to and spaced from an edge of the stack of external tabs 312.

After the plurality of spot tack welds 316-1, . . . , and 316-L are completed, the scanner 132 and the laser 130 lap weld (or edge weld) an edge 320 of the stack of external tabs 312 to the terminal 314. As can be appreciated, the laser weld can partially or fully penetrate the terminal 314.

In some examples, the laser 130 is used for both the spot welds and the laser welding. In other examples, a first laser is used for the spot welds and a second laser is used for the laser welding. In some examples, the second laser creates a lap weld or an edge weld between the stack of external tabs 312 and the terminal 314.

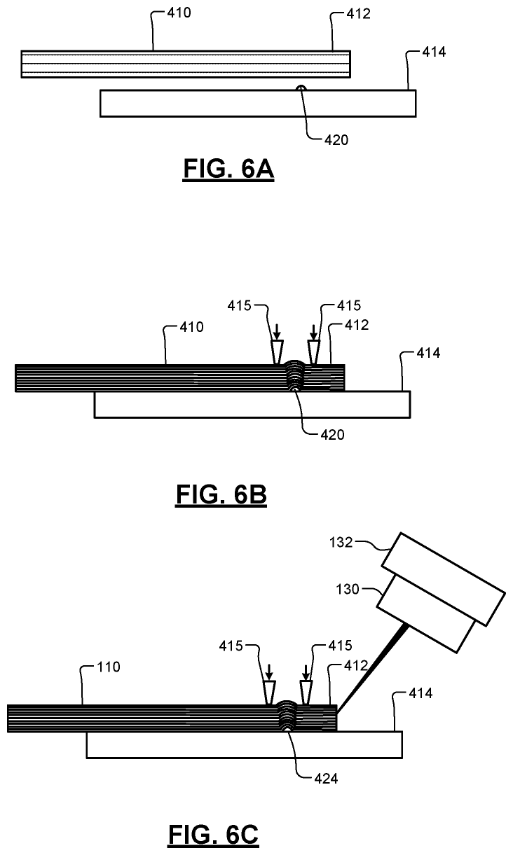

Referring now to FIGS. 6A to 6C, a method for laser welding a stack of external tabs of anode or cathode electrodes to a terminal is shown. In FIG. 6A, a rod 420 is arranged on surface of a terminal 414. A stack of external tabs 412 of anode or cathode electrodes in a battery cell stack 410 is arranged on the rod 420 and the terminal 414. A clamp 415 applies pressure to the stack of external tabs 412 on opposite sides of the rod 420.

The stack of external tabs 412 are deformed by the rod 420 as can be seen in FIG. 6B. In FIG. 6C, the rod 420 is removed after clamping. Since the stack of external tabs 412 is clamped on opposite sides of the rod 420, a gas relief channel 424 is created that extends from one side of the stack of external tabs 412 to the other side. In some examples, the rod 420 has a semicircular, polygonal, rectangular, triangular, square, circular, or other regular or irregular cross-section. The scanner 132 and the laser 130 direct the laser beam onto a top surface and/or an edge of the stack of external tabs 412 to weld the stack of external tabs 412 to the terminal 414. In some examples, the laser weld fully or partially penetrates the terminal 414.

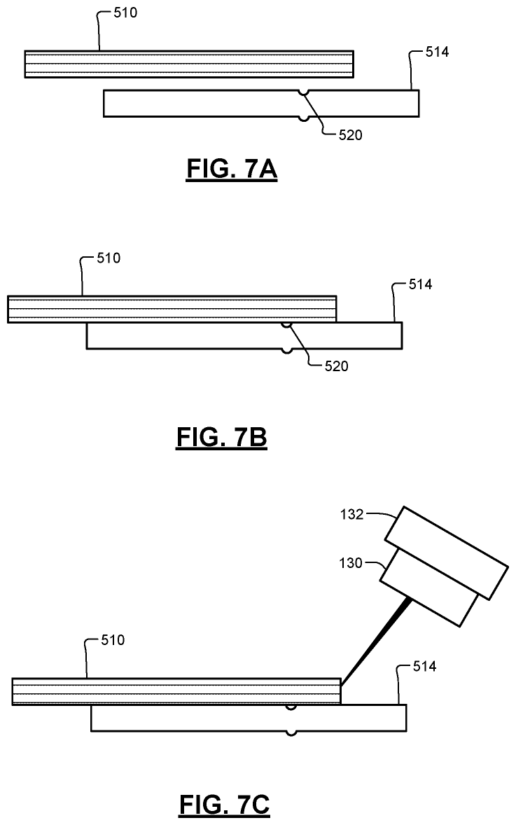

Referring now to FIGS. 7A to 7C, a method for laser welding a stack of external tabs of anode or cathode electrodes to a terminal is shown. In FIG. 7A, a stack of external tabs 512 of anode or cathode electrodes in a battery cell stack 510 is arranged on a terminal 514. The terminal 514 includes a groove 520 extending the width of the terminal 514 and/or the width of the stack of external tabs 512. The groove 520 forms a gas relief channel relative to the stack of external tabs 512 to release weld gases during laser welding. In FIG. 7C, the scanner 132 and the laser 130 direct the laser beam 130 onto a top surface and/or an edge of the stack of external tabs 412 to lap or edge weld the stack of external tabs 412 to the terminal 414. In some examples, the laser weld fully or partially penetrates the terminal 414.

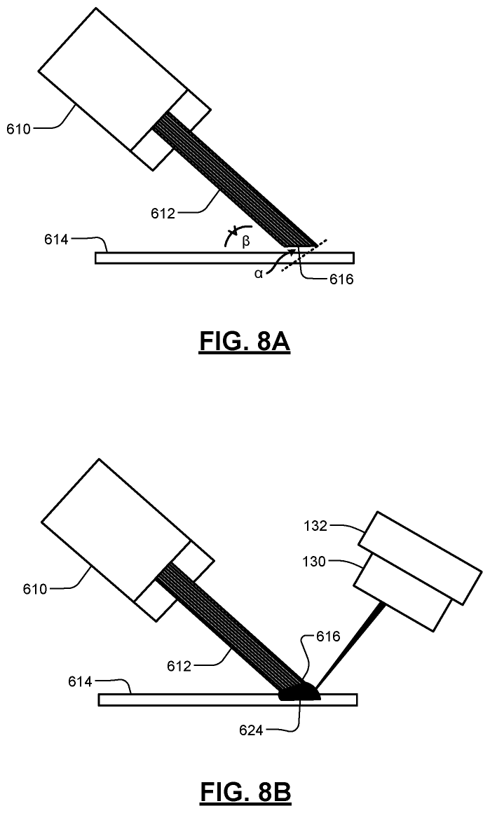

Referring now to FIGS. 8A and 8B, a method for laser welding a stack of external tabs 612 of anode or cathode electrodes of a battery cell stack 610 to a terminal 614 is shown. Ends 616 of the stack of external tabs 612 are optionally trimmed at a first predetermined acute angle α. The battery cell stack 610 is held at a second predetermined acute angle β relative to the terminal 614 (with a trimmed surface of the stack of external tabs 712 facing the terminal 714). In some examples, the first predetermined acute angle α and the second predetermined angle β are the same and/or within +/−10°. In some examples, the first predetermined acute angle α and the second predetermined angle β are in a range from 30° to 60°.

The ends 616 of the stack of external tabs 612 are moved in contact with a weld location on the terminal 614. In some examples, a plane including the ends 616 of the stack of external tabs 612 is aligned with a plane including a facing surface of the terminal 614. In FIG. 8B, the scanner 132 and the laser 130 direct the laser beam across the ends 616 of the stack of external tabs 612 to form a laser weld 624 between the stack of external tabs 612 and the terminal 614. In some examples, the laser weld fully or partially penetrates the terminal 614.

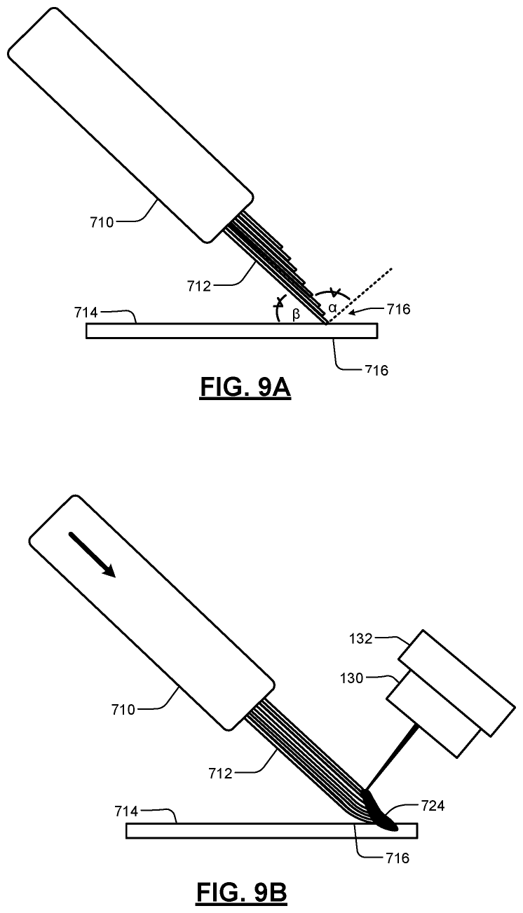

Referring now to FIGS. 9A and 9B, a method for laser welding a stack of external tabs 712 of anode or cathode electrodes of a battery cell stack 710 to a terminal 714 is shown. Ends 716 of the stack of external tabs 712 are trimmed at a first predetermined acute angle α. The battery cell stack 710 is held at a second predetermined acute angle β relative to the terminal 714 (with a trimmed surface of the stack of external tabs 712 facing away from the terminal 714). In some examples, the first predetermined acute angle α and the second predetermined angle β are the same and/or within +/−10°.

The ends 716 of the stack of external tabs 712 are moved into contact with the terminal 614 and the stack of external tabs 612 are allowed to curve or bend. In FIG. 8B, the scanner 132 and the laser 130 direct the laser beam across the ends 716 of the stack of external tabs 712 to form a laser weld 724 between the stack of external tabs 712 and the terminal 714. In some examples, the laser weld fully or partially penetrates the terminal 714.

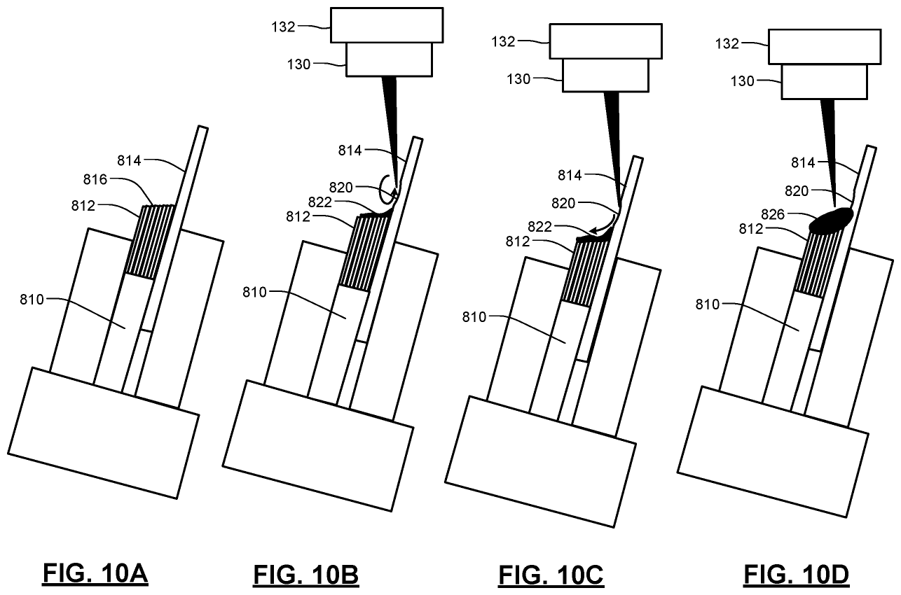

Referring now to FIGS. 10A to 10C, another example of a method for laser welding a stack of external tabs 812 of anode or cathode electrodes of a stack 810 to a terminal 814 using autogenous brazing is shown. The stack 810 may be arranged in a fixture such as a vise during laser welding. The scanner 132 and the laser 130 direct a laser beam onto a surface 820 of the terminal 814 above ends 816 of the stack of external tabs 812. In some examples, the laser beam output by the laser 130 is rotated, oscillated, or moved on the surface of terminal 814.

In some examples, the ends 816 of the stack of external tabs 812 are trimmed at an acute angle (e.g., facing away from a facing surface of the terminal 814) prior to laser welding. In some examples, the terminal 814 and the stack 810 are tilted at an acute angle relative to vertical during laser welding to cause the melted portion 822 of the terminal to flow onto the ends 816 of the stack of external tabs 812. In some examples, a length of the terminal is oriented vertical, within 10° of vertical, within 30° of vertical, or at another suitable angle such that the melted portion of the terminal 814 flows onto the ends 816 of the stack of external tabs 812.

The laser 130 melts the surface 820 of the terminal 814 above the ends 816 of the external tabs 812. A melted portion 822 of the terminal 814 flows downwardly onto the ends 816 of the stack of external tabs 812. Then, the scanner 132 directs the laser 130 onto the melted portion 822 and the ends 816 of the stack of external tabs 812 to laser weld the stack of external tabs 812 to the terminal 814. In some examples, the laser weld fully or partially penetrates the terminal 814.

In some examples, the laser 130 is used for both the melting and the laser welding. In some examples, at least one of laser power, laser scan speed, laser focus/defocus, laser oscillation pattern, workpiece speed, pulse frequency, and/or pulse shape of the first laser is adjusted during melting as compared to during laser welding. In other examples, a first laser is used for the melting of the terminal 814 and a second laser is used for the laser welding. In some examples, the first laser and the second laser use different operating parameters during melting and laser welding.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for joining external tabs of a battery cell to a terminal, comprising:
providing a battery cell stack including:
C cathode electrodes each including a cathode current collector made of foil, a cathode active layer arranged on the cathode current collector, and an external tab extending from the cathode current collector;
A anode electrodes including an anode current collector made of foil, an anode active layer arranged on the anode current collector, and an external tab extending from the anode current collector; and
S separators, where C, S and A are integers greater than one;
arranging a stack of external tabs of one of the C cathode electrodes and the A anode electrodes on a terminal;
laser melting ends of the stack of external tabs; and
after the laser melting, laser welding the stack of external tabs of the one of the C cathode electrodes and the A anode electrodes to the terminal.

2. The method of claim 1, wherein a first laser heats the ends of the stack of external tabs and performs the laser welding.

3. The method of claim 2, further comprising adjusting at least one of laser power, laser scan speed, laser focus/defocus, laser oscillation pattern, workpiece speed, pulse frequency, and/or pulse shape of the first laser between the laser melting and the laser welding.

4. The method of claim 1, wherein a first laser performs laser melting and a second laser performs the laser welding.

5. The method of claim 4, wherein the first laser uses different operating parameters than the second laser.

6. The method of claim 4, wherein at least one of laser power, laser scan speed, laser focus/defocus, workpiece speed, laser oscillation pattern, pulse frequency, and/or pulse shape of the second laser is different than the first laser.

7. A method for joining external tabs of a battery cell to a terminal, comprising:
providing a battery cell stack including:
C cathode electrodes each including a cathode current collector made of foil, a cathode active layer arranged on the cathode current collector, and an external tab extending from the cathode current collector;
A anode electrodes including an anode current collector made of foil, an anode active layer arranged on the anode current collector, and an external tab extending from the anode current collector; and
S separators, where C, S and A are integers greater than one;
arranging a stack of external tabs of one of the C cathode electrodes and the A anode electrodes on a terminal;
creating L spot welds between the stack of external tabs and the terminal using a laser, where L is an integer greater than one; and
laser welding the stack of external tabs of the one of the C cathode electrodes and the A anode electrodes to the terminal.

8. The method of claim 7, wherein a first laser forms the L spot welds and performs the laser welding.

9. The method of claim 8, further comprising adjusting at least one of laser power, laser scan speed, laser focus/defocus, laser oscillation pattern, workpiece speed, pulse frequency, and/or pulse shape of the first laser between the L spot welds and the laser welding.

10. The method of claim 7, wherein a first laser forms the L spot welds and a second laser performs the laser welding.

11. The method of claim 10, wherein the first laser uses different operating parameters than the second laser.

12. The method of claim 10, wherein at least one of laser power, laser scan speed, laser focus/defocus, workpiece speed, laser oscillation pattern, pulse frequency, and/or pulse shape of the second laser is different than the first laser.

13. The method of claim 7, wherein the laser welding comprises at least one of a lap weld and an edge weld.

14. A method for joining external tabs of a battery cell to a terminal, comprising:
providing a battery cell stack including:
C cathode electrodes each including a cathode current collector made of foil, a cathode active layer arranged on the cathode current collector, and an external tab extending from the cathode current collector;
A anode electrodes including an anode current collector made of foil, an anode active layer arranged on the anode current collector, and an external tab extending from the anode current collector;
S separators, where C, S and A are integers greater than one; and
forming a gas relief channel between a stack of external tabs of the one of the C cathode electrodes and the A anode electrodes and a terminal; and
laser welding the stack of external tabs of the one of the C cathode electrodes and the A anode electrodes to the terminal.

15. The method of claim 14, wherein forming the gas relief channel includes:
arranging a rod on a terminal; and
arranging a stack of external tabs of one of the C cathode electrodes and the A anode electrodes on the rod and the terminal to form the gas relief channel.

16. The method of claim 15, wherein a cross section of the rod is selected from a group consisting of semicircular, rectangular, polygonal, triangular, square, and circular.

17. The method of claim 15, wherein forming the gas relief channel further includes:
clamping the stack of external tabs of one of the C cathode electrodes and the A anode electrodes to the terminal on opposite sides of the rod; and
removing the rod between the stack of external tabs of one of the C cathode electrodes and the A anode electrodes and the terminal prior to the laser welding.

18. The method of claim 14, wherein the terminal includes a groove and the gas relief channel is formed between the stack of external tabs of the one of the C cathode electrodes and the A anode electrodes and the groove of the terminal.

19. The method of claim 9, wherein the laser welding comprises at least one of a lap weld and an edge weld.
